(19) United States
(12) Patent Application Publication
(10) Pub. No.: US 2010/0064621 A1
(43) Pub. Date: Mar. 18, 2010

(54) Cinder block construction system and method

(76) Inventors: Joseph B. Steiger, North Wildwood, NJ (US); Ernest L. Bancroft, Newtown, PA (US)

Correspondence Address: Hollstein Keating Cattell Johnson & Goldstein PC;Willow Ridge Executive Office Park, Suite 301, 750 Rt. 73. S., Marlton, NJ, 08053, US

(21) Appl. No.: 12/283,951

(22) Filed: Sep. 17, 2008

(51) Int. Cl. E04C 2/04; B32B 7/04

(52) U.S. Cl. 52/596; 156/91

(57) ABSTRACT

A cinder block construction system employs a cinder block component with top and side surfaces and cavities extending downwardly from the top surface. Solid body inserts are located in the cavities and are permanently bonded to the cavities' sidewalls. The inserts are composed of material specifically adapted to allow penetration into the body by a connector element. The connector element secures the cinder block component to a construction member such as a sill plate or door or window jamb. The cinder block component can be prepared with its insert in advance, or the insert material dispensed to the cinder block component at the worksite to convert a standard cinder block to one which can readily be connected to a separate construction member.

### BACKGROUND OF THE INVENTION

Cinder blocks and similar concrete and masonry structures have long been and continue to be favored and commonly used building components in the construction industry. Cinder blocks, especially, provide the fundamental, permanent support for many structures, including foundations, walls, flooring etc. Cinder blocks are relatively economical to manufacture and their block configuration allows for ease of installation.

Cinder blocks are also versatile in the manner they are used in the construction process. The basic design of cinder blocks, with their through cavities, allows them to be used with studs to create spacers for insulation or for supporting dry wall. Electrical wiring and piping are often run through cinder block cavities. Cavities sometimes are reinforced to accept and secure joist anchors and other connector elements. Certain cinder block cavities are filled with insulating material or insulation inserts.

While the versatility of cinder blocks and cinder block construction is well known, there presently is no integral self-contained cinder block component which specifically provides for a quick and ready connection to a separate construction member like a sill plate, door and window jamb, or similar component. Similarly, there is no method of cinder block construction which uses such an integral, self-contained cinder block component to efficiently and easily accomplish this connection. Further, there is no method of converting, at the worksite, standard cinder block components to cinder block components which can be readily connected to a separate construction member.

In addition, in preparing cinder block and similar concrete and masonry structures for attachment to sill plates and other construction components, holes must be drilled into the masonry for the connecting screws. Such pre-drilling often results in breakage of the cinder block components, leading to the use of more components than would otherwise be necessary. Also, the particular drill bits which are required to drill through the concrete or masonry material are expensive and must be replaced frequently. There is currently no cinder block component or similar structural element which addresses this problem.

### SUMMARY OF THE INVENTION

It is thus the object of the present invention to overcome the limitations and deficiencies of prior cinder block construction systems.

It is an object of the present invention to provide a cinder block construction system and method which uses a unique, integral self-contained cinder block component to easily, efficiently and effectively connect cinder block components to separate construction members, such as sill plates and door and window jambs.

It is a further object of the present invention to provide a cinder block construction system and method which uses a unique, integral, self-contained cinder block component containing an insert material which is specifically designed to permit penetration by a connector element, for connecting construction members to the cinder block component.

It is another object of the present invention to provide a cinder block construction system and method which permits standard cinder block components to be converted, at the worksite, to components which can readily be connected to a separate construction member.

It is a further object of the present invention to provide a cinder block construction system and method which uses a unique cinder block component with connection insert which will markedly decrease pre-drilling breakage of cinder block components and damage to and frequent replacement of drill bits.

It is still another object of the present invention to provide a cinder block construction system and method which provides for unique, integral, self-contained cinder block components which are economical to manufacture and easy to use.

These and other objects are accomplished by the present invention, a cinder block construction system which employs a cinder block component with top and side surfaces and cavities extending downwardly from the top surface. Solid body inserts are located in the cavities and are permanently bonded to the cavities' sidewalls. The inserts are composed of material specifically adapted to allow penetration into the body by a connector element. The connector element secures the cinder block component to a construction member such as a sill plate or door or window jamb. The cinder block component can be prepared with its insert in advance, or the insert material dispensed to the cinder block component at the worksite to convert a standard cinder block to one which can readily be connected to a separate construction member.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the cinder block of the present invention.

FIG. 1A is a section taken from FIG. 1.

FIG. 2 is an isometric view of the manner of use of the cinder block and connector elements of the present invention.

### DETAILED DESCRIPTION OF THE INVENTION

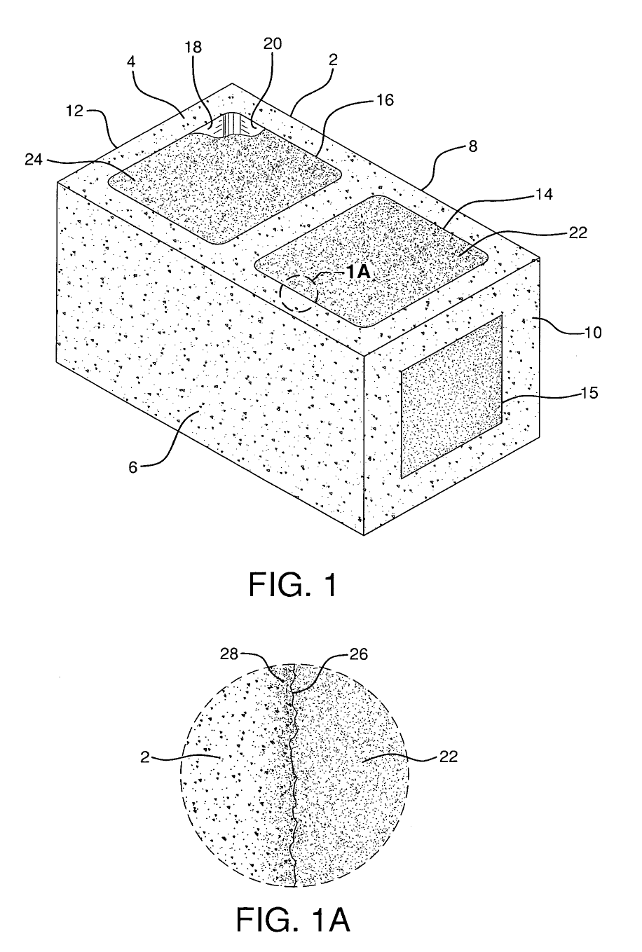

The cinder block construction system of the present invention comprises cinder block component 2, typically made of concrete or other masonry material, having a unitary body. Cinder block component 2 comprises top surface 4, side surfaces 6, 8, 10, and 12 and cavities 14 and 16, with sidewalls 18 and 20 (shown in FIG. 1 for cavity 16) extending downward from top surface 4. Side opening 15 is included in the cinder block 2 shown in FIG. 1, to depict additional, related uses of the cinder block. Cinder blocks used for foundation and wall construction normally do not have this opening.

Cavities 14 and 16 contain solid inserts 22 and 24 which are adhered, by bonding to the sidewalls of each cavity. Solid inserts 22 and 24 are composed of a joining compound which is injected, poured or otherwise dispensed into cavities 14 and 16, either in advance of the construction work for delivery to the worksite, or at the worksite itself where standard cinder block components are converted to block components of the present invention. It is contemplated that the insert material constitutes an adhesive inclusive joining compound, liquid upon its application, which will bond not only to concrete and masonry products, but also to metal, wood, and certain plastics. The joining compound is rapidly setting and will harden and solidify into a high tensile, high compressive strength material, capable of allowing penetration by and retention of a construction connector element, such as a lag bolt or equivalent connector. Such material can be a rapid acting adhesive epoxy, resin, or similarly performing compound.

FIG. 1A shows interface 26 between solid insert 22 and cinder block component 2. Bond 28 forms from solid insert 22, which infiltrates into the concrete, masonry or other material of the cinder block component. Thus, once applied into cavities 14 and 16 of cinder block component 2, solid inserts 22 and 24 become integrally bonded to or fused within the cavities' side walls and thus to the body of the cinder block itself.

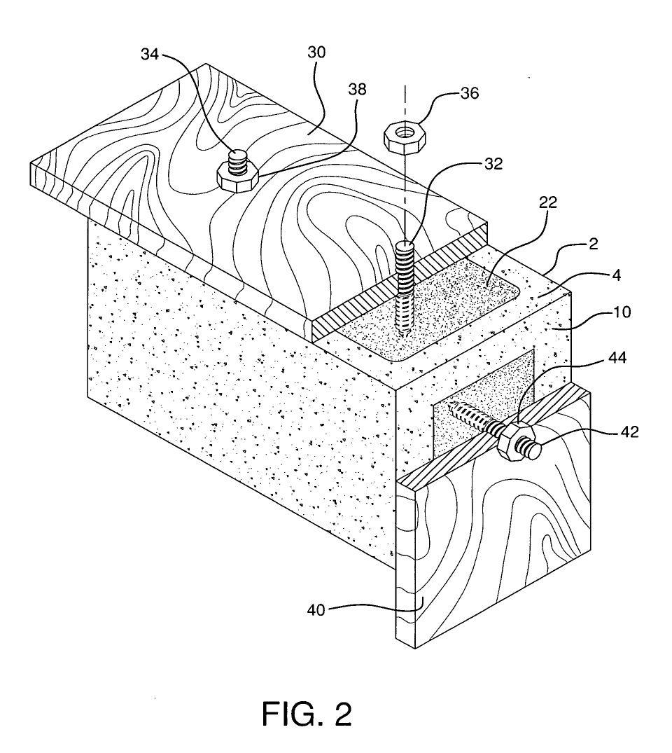

The construction method which employs the unique cinder blocks of the invention is exemplified by reference to FIG. 2. Cinder block component 2, with solid insert 22 in place, is positioned in the desired construction location. Connector elements, in the form of threaded lag bolts 32 and 34, are screwed or otherwise penetrated into solid insert 22. A separate construction member, such as sill plate 30 provided with pre-cut, measured holes, is placed onto top surface 4 of cinder block component 2, such that lag bolts 32 and 34 extend through the sill plate. Nuts 36 and 38 are then threadably secured to lag bolts 32 and 34 to connect sill plate 30 to cinder block component 2. In like manner, connector element, lag bolt 42, is penetrated into solid insert 22 through side opening 15. Lag bolt 42 is then inserted through a pre-cut measured hole in door or window jamb 40, which is placed on and over side surface 10 of cinder block component 2, such that lag bolt 42 extends through the jamb. Nut 44 is threadably secured to lag bolt 44 to connect jamb 40 to cinder block component 2.

Thus, by the unique, integral, self-contained cinder block components of the present invention and its manner of use, a variety of building and construction components can easily be secured to cinder blocks, thereby enhancing the efficiency of the overall construction process. Since the use of the cinder block components of the present invention eliminates the need for pre-drilling and thus the wasteful damage to standard concrete and masonry components and the resultant destruction of drill bits, economy of construction is similarly enhanced.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A construction member comprising:
a cinder block component having a unitary body and top and side surfaces and at least one cavity with side walls extending downwardly from the top surface; and
means located within the cavity to facilitate the connection of the cinder block component to a separate construction member positioned on the top surface or side surface of the cinder block component, said means comprising a solid insert substantially filling the cavity, said solid insert being permanently bonded through the side walls of the cavity and into the body of the cinder block component and being composed of a material which allows penetration into the solid insert by and retention of a connector element, whereby after penetration by a connector element, the connector element is configured to secure the cinder block component to the separate construction member.

2. The construction member as in claim 1 wherein the solid insert comprises a liquid material when dispensed which solidifies into a rapidly setting, high tensile, high compressive strength material.

3. The construction member as in claim 1 wherein the material of the solid insert is infiltrated within and bonded to the body of the cinder block component.

4. A building construction system comprising:
at least one connector element;
at least one cinder block component having a unitary body and top and side surfaces and at least one cavity with side walls extending downwardly from the top surface; and
means located within the cavity to facilitate the connection of the cinder block component to a separate construction member positioned on the top surface or side surface of the cinder block component, said means comprising a solid insert substantially filling the cavity, said solid insert being permanently bonded through the side walls of the cavity and into the body of the cinder block and being composed of a material which allows penetration into the solid insert by and retention of said connector element, whereby after penetration by the connector element, the connector element is configured to secure the cinder block component. to the separate construction member.

5. The building construction system as in claim 4 wherein the solid insert comprises a liquid material when dispensed which solidifies into a rapidly setting, high tensile, high compressive strength material.

6. The building construction system as in claim 4 wherein the material of the solid insert is infiltrated within and bonded to the body of the cinder block component.

7. A method of building construction comprising the steps of:
providing a cinder block component having top and side surfaces and at least one cavity with sidewalls extending downwardly from the top surface;
substantially filling the cavity with a liquid material which, when dispensed, solidifies into a rapidly setting, high tensile, high compressive strength penetrable material;
bonding the material to the sidewalls of the cavity such that the material infiltrates the sidewalls of the cavity of the cinder block component;
providing a connector element;
penetrating the material with the connector element;
securing the connector element within the material;
placing a separate construction member on the top surface or side surface of the cinder block component, over the connector element; and
securing the separate construction member to the cinder block component.

8. The method as in claim 7 wherein the separate construction member is a sill plate.

9. The method as in claim 7 wherein the separate construction member is a door or window jamb.
